(19) United States
(12) Patent Application Publication
(10) Pub. No.: US 2009/0003371 A1
(43) Pub. Date: Jan. 1, 2009

(54) METHOD FOR TRANSMITTING PACKET AND NETWORK SYSTEM THEREOF

(75) Inventors: Ray-Guang Cheng, Keelung City (TW); Li-Hung Liao, Taipei City (TW)

Correspondence Address: J C PATENTS, INC., 4 VENTURE, SUITE 250, IRVINE, CA, 92618, US

(73) Assignee: National Taiwan University of Science and Technology, Taipei City (TW)

(21) Appl. No.: 11/937,020

(22) Filed: Nov. 8, 2007

(30) Foreign Application Priority Data
Jun. 29, 2007 (TW) 96123756

(51) Int. Cl. H04L 12/56

(52) U.S. Cl. 370/412; 370/401

(57) ABSTRACT

A method for transmitting packets and a network system thereof are provided. In the present invention, each packet entering the network system is added an assigning tag to indicate the arrival time of the packet, and at least two queues in a node of the network system are used for respectively sorting the local packets of the node and the relayed packets of the preceding node. The order of the packet for transmitting can be decided by comparing the assigning tags of the two packets positioned at first order in different queues. Therefore, a condition of First-In First-Out (FIFO) is satisfied in the network system, and the sequence for transmitting packets is arbitrated fair.

### CROSS-REFERENCE TO RELATED APPLICATION

This application claims the priority benefit of Taiwan application serial no. 96123756, filed on Jun. 29, 2007. The entirety of the above-mentioned patent application is hereby incorporated by reference herein and made a part of this specification.

### BACKGROUND OF THE INVENTION

1. Field of the Invention

The present invention relates to a mechanism for transmitting packets, and more particularly to a method for transmitting packets capable of determining the order of the packets for transmitting by using an assigning tag in each packets, and a network system thereof.

2. Description of Related Art

Recently, with the rapid development of science and technology, portable electronics (such as notebooks, mobile phones and PDAs) are increasingly prevailing accordingly. Therefore, for the current communication industry, wireless local area network (WLAN) has become an important technology. Currently, the WLAN has been gradually switched to outdoors and wide area application environment from the indoors and local area environment. At present, the construction of the wireless network is realized by wirelessly linking several access points (APs), for transmitting the data step by step to a gateway connected with a wired network in a multi-hop manner, so as to serve a switching points between the wireless network and the wired network.

FIG. 1 is a schematic view of a conventional wireless network system. Referring to FIG. 1, a topology of the wireless network system is a wireless chain topology. Referring to FIG. 1, six APs 101-106 and a gateway 140 are disposed in the wireless network system. Upon closely observing FIG. 1, it can be easily found that, in the wireless chain network, since the distances between the various APs 101-106 and the gateway 140 are different, the end to end bandwidth resource distribution is not uniform. For example, the transmission of data stream of the AP 101 to the gateway 140 requires 6 hops; on the contrary, the transmission of the data stream of the AP 106 to the gateway 140 only requires 1 hop. In other words, the AP 101 generates a packet first, the AP 105 then generates a packet. However, it is very likely that the packet of the AP 105 reaches the gateway 140 earlier than that of the AP 101, and thus the bandwidth resources distributed to the AP 105 near the gateway 140 is more than that distributed to the AP 101 away from the gateway 140 accordingly.

In the other aspect, each AP may include the packet transmitted from the preceding AP and a local packet. In conventional packet-transmitting mechanism, the packets are transmitted according to the time sequence for the packets to arrive at the AP. For example, if two users were booking tickets over the wireless network system at the AP 101 and the AP 105 respectively, however, as the AP 105 is closer to the gateway 140, and it is much easier for the user at the AP 105 to successfully book the ticket over network than the user at the AP 101. In other words, this wireless network system easily causes unfairness in transmission. Accordingly, it is a big challenge to determine a packet transmission order to prevent the unfairness on bandwidth distribution.

### SUMMARY OF THE INVENTION

Accordingly, the present invention is directed to a method for transmitting packet, which fairly arbitrates sequence for relaying packets by using assigning tags in the packets.

The present invention is further directed to a network system capable of distributing the same network bandwidth to nodes in the network system no matter the node is near or away from the gateway.

As embodied and broadly described herein, the present invention provides a method for transmitting packet, applicable to a multi-hop network including a plurality of nodes. The method includes the following steps: first, an assigning tag is added to a packet when the packet entering the multi-hop network; next, a node among the nodes in the multi-hop network sorts received packets relayed by another node into a relay queen according to the time when the packets are received, and a specific node sorts locally-generated packets into a local queue according to the time when the packets are generated; then, the specific node determines whether a packet at the first order in the relay queue or a packet at the first order in the local queue to be a specific packet according to the assigning tags of the packet at the first order in the relay queue and the packet at the first order in the local queue; and finally, the specific node transmits the specific packet.

From another point of view, the present invention further provides a network system, applicable to a multi-hop network. The network system includes a first node and a second node, the second node receives packets outputted from the first node, sorts the packets into a relay queue according to the time when the packets are received, and sorts the locally-generated packets into a local queue according to the time when the packets are generated. When each of the packets enters the network system, an assigning tag is added. The second node compares the assigning tag of a packet at the first order in the relay queue with that of a packet at the first order of the local queue, so as to determine to transmit the packet at the first order in the relay queue or the packet at the first order in the local queue.

In an embodiment of the present invention, the assigning tag of each packet is, for example, a time when the packet is generated, a time when the packet arrives in the network system, or a serial number of the packet arriving in the network system. In addition, each packet satisfies a frame format including a source address field, a transmitter address field, and a tag field. The tag field is used for recording the assigning tag.

In an embodiment of the present invention, upon receiving a packet, the above node determines whether the address recorded in the transmitter address field is the same as the address recorded in the source address field in the received packet. When it is determined that the address recorded in the transmitter address field is different from the address recorded in the source address field, the received packet is sorted to the relay queue. In addition, when it is determined that the address recorded in the transmitter address field is the same as that recorded in the source address field, an assigning tag is written in the tag field in the received packet, and the packet is sorted to the local queue.

In the present invention, at least two queues in a node are used for sorting the locally-generated packets and the relayed packets of the preceding node respectively. The relayed packets of the preceding node are sorted according to the time when the packets are received, and the locally-generated packets are sorted according to the time when the packets are generated. In addition, in the present invention, an assigning tag is added to each packet when the packet enters the network system, so as to indicate the time when each packet arrives in the network system, and when the node relays the packets, the order for relaying the packets is determined by using the assigning tags. Accordingly, the specific packet to be transmitted can be determined merely by comparing the assigning tags corresponding to the two packets at the first order in the two queues. Therefore, a condition of First-In First-Out (FIFO) is satisfied in the network system, and the sequence for transmitting packets is arbitrated fair.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional wireless network.

FIG. 2 is a block diagram of a network system according to an embodiment of the present invention.

FIG. 3 is a flow chart of a method for transmitting packets according to an embodiment of the present invention.

FIG. 4A is a schematic view of MAC frame format in IEEE 802.11 protocol according to an embodiment of the present invention.

FIG. 4B is a schematic view of a data frame according to an embodiment of the present invention.

FIG. 5 is a schematic view of a wireless chain network queues according to an embodiment of the present invention.

FIGS. 6A-6C are partially enlarged schematic views of FIG. 5 according to an embodiment of the present invention.

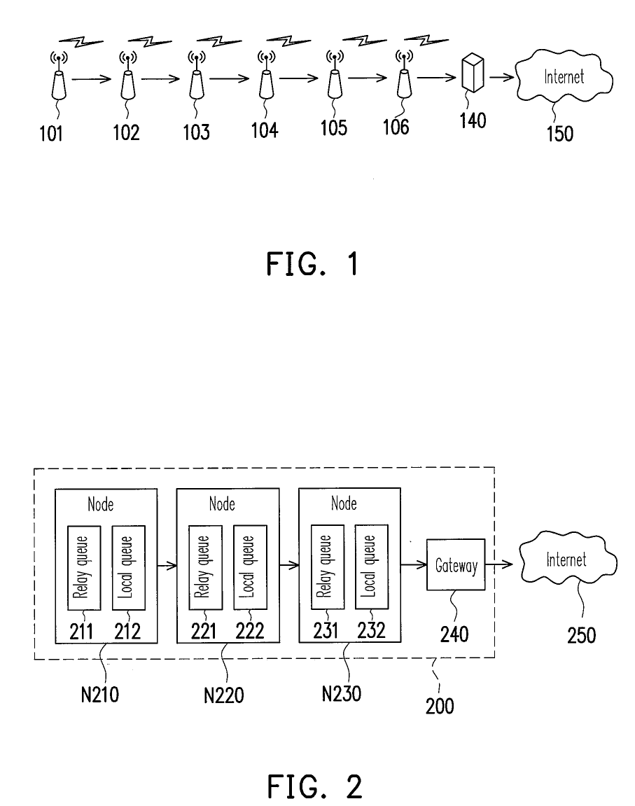

### DESCRIPTION OF EMBODIMENTS

FIG. 2 is a block diagram of a network system according to an embodiment of the present invention. Referring to FIG. 2, the network system 200 includes a first node N210, a second node N220, a third node N230 and a gateway 240.

In order to conveniently illustrate this embodiment, the following assumptions are made. First, it is assumed that the network system 200 is a wireless backhaul network, and the nodes N210-N230 of the wireless network 200 can be access points (APs), personal computers, or PDAs. Next, it is assumed that the topology of the wireless network 200 is a wireless chain topology, and the nodes N210-N230 in the wireless network 200 transmit packets in a multi-hop linking manner. However, those of ordinary skill in the art can implement the present invention in various wireless networks depending upon actual requirements through the illustration of the embodiments, and thus the above assumptions are not intended to limit the present invention.

The packets generated by the node N210 must be relayed to the gateway 240 through three hops, that is to say, the packets generated by the node N210 are sequentially relayed to the gateway 240 through the node N220 and the node N230. Similarly, the packets generated by the node N220 must be transmitted to the gateway 240 through two hops, and the packets generated by the node N230 can be transmitted to the gateway 240 only through one hop. As for the conventional wireless network, the node N230 is closer to the gateway 240, and thus it can easily obtain the distributed network resource, in other words, it is much easier for the packets generated by the node N230 to be transmitted to the gateway 240 than that of the node N210.

In order to solve the unfairness in packet transmission caused by the conventional wireless network, in this embodiment, an assigning tag is added to each of the packets that enter the network system 200, and the nodes N210-N230 will determine the order for relaying the packets by using the assigning tags in the packets. The above assigning tag can be a time when the packet is generated, a time when the packet arrives in the network system 200 or a serial number of the packet etc., and any information capable of representing the sequence of the packets arriving in the network system 200 or the sequence when the packets are generated can all be used as the assigning tag. In order to conveniently illustrate this embodiment, the following assigning tags are, for example, the time when the packet enters the network system.

Moreover, in this embodiment, the nodes N210-N230 must relay packets generated by other nodes, so in the network system 200 provided by this embodiment of the present invention, the nodes N210-N230 all have a relay queue (211, 221, 231) and a local queue (212, 222, 232), in which the relay queue (211, 221, 231) is used to store the packets relayed from other nodes, and the local queue (212, 222, 232) is used to store the locally-generated packets. The operation of the network system 200 provided in this embodiment is illustrated below.

First, the node N210 generates packets P1 and P2, and it is assumed that the packet P1 is generated earlier than the packet P2. In other words, the packets P1 and P2 enter the network system 200 in sequence. In this embodiment, the packets P1 and P2 can be the local packets generated by the node N210 itself, or packets generated by users in the range of the areas responsible by the node N210. After the node N210 generates the packet P1, the node N210 adds an assigning tag into the packet P1 for recording the time when the packet P1 enters the network system 200, and sorts the packet P1 into the local queue 212. Similarly, the node N210 also adds an assigning tag into the packet P2, and sorts the packet P2 into the local queue 212. At this time, a first order of the local queue 212 in the node N210 is the packet P1, and a second order is the packet P2. Next, once the node N210 is capable of accessing a wireless channel, the node N210 first selects to transmit the packet P1 to the node N220, and then selects to transmit the packet P2 to the node N220 in sequence.

After the node N220 receives the packets P1 and P2 from the node N210, the node N220 sorts the packets P1 and P2 into the relay queue 221 according to the sequence when the packets are received. The node N220 also generates local packets, and in this embodiment, it is assumed that the node N220 itself generates a local packet P3. That is to say, the packet P3 enters the network system 200, and the node N220 also adds an assigning tag into the packet P3, for recording the time when the packet P3 enters the network system 200, and sorts the packet P3 into the local queue 222. At this time, in the relay queue 221 of the node N220, the first order is the packet P1, the second order is the packet P2. In the local queue 222 of the node N220, the first order is the packet P3.

Next, once the node N220 is capable of accessing the wireless channel, it is determined to transmit one of the packets P1, P2 and P3 to the node 230. In this embodiment, since the packets P1, P2 and P3 all have an assigning tag, the node N220 compares the assigning tags of the packets P1, P2 and P3 to determine the one to be relayed first, i.e., the node N220 relays the one that enters the network system 200 much earlier.

If the node N220 must check the assigning tags of all packets therein when relaying the packets each time, the operations of the node are greatly wasted and much power is consumed. Therefore, in this embodiment of the present invention, the relay queue and the local queue are disposed in the node, such that when comparing assigning tags by the node N220, only the packet at the first order in the relay queue 221 and that at the first order in the local queue 222 are compared to determine which one of the two packets is transmitted first, without considering the assigning tags of all packets in the node N220.

That is to say, as the nodes all determines the order for relaying the packets according to the time when the packets enter the network system 200, each node only needs to store the packets into the relay queue according to the time when the packet is received, such that the sorting of the packets in the relay queue is performed according to the time when the packets enter the network system 200. Moreover, each node also sorts the local packets in the local queue according to the time when the packets are generated. Therefore, each node only needs to compare the assigning tag of the packet at first order in the local queue with that of the packet at the first order in the relay queue therein, and then relay the packets according to the comparison result, which can ensure that the relayed packet is the earliest generated packet among all packets, and thus the distribution of the network resources is more fair.

Similarly, the operation of the node N230 is similar to the operation of the node N220. The packets received from the preceding node N220 are sorted in a relay queue 231 according to the receiving sequence, and the locally-generated packets are sorted in a local queue 232 according to the generation time. The operation of the node N230 is the same as the operation of other nodes, and thus is not described herein.

The gateway 240 in FIG. 2 is used to offer interworking functions required for connecting the nodes N210-N230 to various forms of network systems (e.g., Internet 250 in FIG. 2). Different forms of network systems may have different communication protocols, so the gateway 240 can be used to convert among different communication protocols, such that packets can be transmitted between different forms of networks. In this embodiment, when the gateway 240 receives the packets relayed by the node 230, the gateway 240 first converts the communication protocol of the packet, and then outputs the packet having the converted communication protocol to the Internet 250.

In order to conveniently illustrate the present invention, only packets P1, P2 and P3 are listed above. However, in practical applications, the number of the packets is definitely more than three. Therefore, the number of packets described above does not limit the scope of the present invention. Moreover, in this embodiment, it is assumed that there is no preceding node ahead of the node N210, and thus the packets are transmitted according to the sequence of the generation of the packet P1 and the packet P2, which is only used for illustration herein, but not for limiting the implementing scope of the present invention.

In addition, as for software implementation, in the relay queues 211, 221, 231 and the local queues 212, 222, 232 of this embodiment, addresses for storing the queues can be assigned by means of link list or through using indexes. As for hardware implementation, the relay queues and the local queues in the nodes are sorted by using two pre-planned memory spaces by means of, for example, allocating the memory. However, it is only demonstrated as examples, and the measures of the present invention are not limited to the above manners.

It can be observed from the above embodiment that, in this embodiment, assigning tags are added in the packets, such that each node can determine the order for relaying the packets by using the assigning tags in the packets, and the packet entering the network system 200 earlier can be transmitted to the gateway earlier, thereby solving the problem of unfair resource distribution in the network system. In addition, the node of this embodiment has two queues for respectively sorting the received packets and locally-generated packets, so when the node compares the assigning tags, it only needs to compare the packets at the first order in the two queues, thereby reducing the operations of the node.

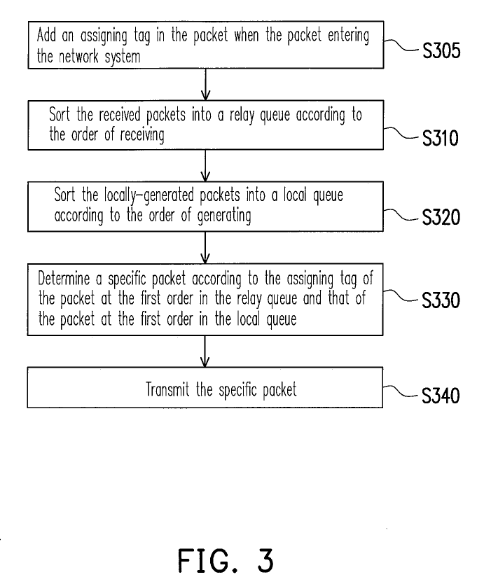

A method for transmitting packets can be concluded according to the packet scheduling mechanism in the above network system 200. FIG. 3 is a flow chart of a method for transmitting packets according to an embodiment of the present invention. Referring to FIGS. 2 and 3, for the convenience of illustrating this embodiment, only the node N210 and the node N220 in the network system 200 are cited in the following method for transmitting packets to illustrate various steps for transmitting the packets. In addition, only packets P1, P2 and P3 are cited in this embodiment for clearly illustrating the spirit of the present invention, however, this setting is not used to limit the scope of the present invention. The method for transmitting packets provided in this embodiment is described below.

First, the nodes in the network system 200 add an assigning tag into the packets entering the network system 200 (Step S305). It can be known from the above assumption and illustration that, in Step S305, the node N210 adds an assigning tag to the generated packets P1 and P2 respectively, so as to record the time when the packets P1 and P2 are generated, that is, recording the time when the packets P1 and P2 enter the network system 200. The node N220 adds an assigning tag to the generated packet P3, so as to record the time when the packet P3 is generated, that is, recording the time when the packet P3 enters the network system 200.

Next, the node N220 receives the packets P1 and P2 output by the node N210, and sorts the packets into the relay queue 221 according to the receiving time of the packets (Step S310). Particularly, the node N210 transmits the packet P1 and the packet P2 to the node N220 according to the order of generation. For example, the packet P1 is generated earlier than the packet P2, such that the node N210 first transmits the packet P1 to the node N220. After receiving the packet P1, the node N220 sorts the packet P1 to the first order of the relay queue 221. Then, when the node N220 receives the packet P2, similarly, the node N220 also sorts the packet P2 to the relay queue 221. Therefore, the second order of the relay queue 221 in the node N220 is the packet P2.

Then, the node N220 sorts the locally-generated packet P3 into the local queue 222 according to the receiving sequence of the packet (Step S320). At this time, the packet at the first order in the relay queue 221 of the node N220 is P1, and the packet at the second order is P2. The packet at the first order in the local queue 222 of the node N220 is P3.

Then, the node N220 determines to take the packet P1 at the first order in the relay queue 211 or the packet P3 at the first order in the local queue 222 as the specific packet according to the assigning tags in the packet P1 at the first order in the relay queue 211 and the packet P3 at first order in the local queue 222 (Step S330). That is to say, the second node 220 only needs to compare the assigning tag of the packet P1 with that of the packet P3 to know which one enters the network system 200 earlier, and the packet entering the network system 200 earlier is taken as the specific packet. As for the above example, the packet P1 is generated earlier than the packet P3, and the assigning tag records the time when the packet is generated, so the node N220 selects the packet P1 as the specific packet. Finally, the node N220 transmits the selected specific packet P1 (Step S340), i.e., transmits the specific packet P1 to the next adjacent node N230.

The above embodiment is described below by using a practical example. If the node N210 generates the packet P1 at “8:00”, and then transmits the packet P1 to the node N220. The node N220 generates the packet P3 at “8:03”. Thereafter, due to delay of transmission or waiting for channel access, the node N220 receives the packet P1 at “8:05”. In the conventional wireless network, as the node N220 obtains the packet P3 at “8:03”, and obtains the packet P1 at “8:05”, the node N220 transmits the packet P3 first, such that the packet P3 is transmitted to the gateway 240 earlier than the packet P1, thereby causing an unfair transmission of packets.

However, in this embodiment, the node N220 determines the order for relaying the packets according to the assigning tags in the packets, and the assigning tags have recorded that the packet P1 is generated earlier than the packet P3. Therefore, the node N220 first transmits the packet P1 to the next node, and thereby solving the problem of unfair transmission of packets in the conventional wireless network.

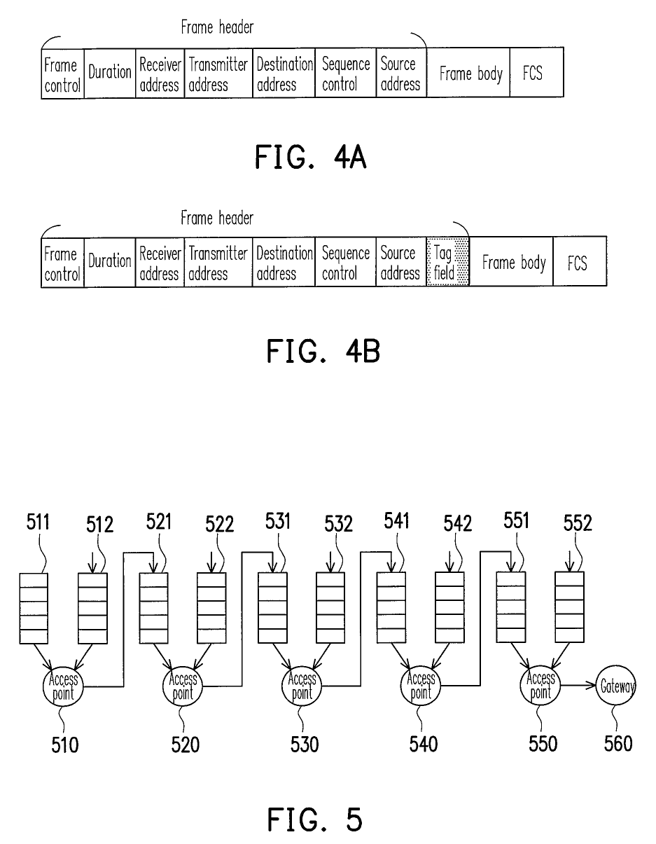

In the current IEEE 802.11 protocol, each packet satisfies an MAC frame format. FIG. 4A is a schematic view of the MAC frame format in the IEEE 802.11 protocol according to an embodiment of the present invention. Referring to FIG. 4A, the MAC frame includes three parts, namely, header, frame body, and frame check sequence (FCS). The frame header further includes a plurality of fields including frame control, duration, receiver address, transmitter address, destination address, sequence control and source address.

When the present invention is implemented in the IEEE 802.11 protocol, an additional tag field is added in the MAC header to record the assigning tag provided in this embodiment. That is to say, in the above embodiment, when the packets P1, P2 and P3 are generated, information about the time when the packet enters the network is written in the tag field added in the MAC header. FIG. 4B is a schematic view of the frame format according to an embodiment of the present invention. Referring to FIG. 4B, the first seven fields in the frame header are the same as those in FIG. 4A, but an additional tag field is added in the frame header to recording the assigning tags corresponding to the packets.

Moreover, in the frame format of FIG. 4B, the source address of the frame header can be used to determine the source of the packets, so as to sort the packets into the corresponding queues. Taking the node N220 as an example, when the node N220 obtains the packets P1 and P2, the node N220 checks the source address field and the transmitter address in the packets P1 and P2. When the node N220 finds that the source address is different from the transmitter address, it indicates that the packets P1 and P2 are the packets relayed by other nodes. Therefore, the node N220 sorts the packets P1 and P2 in the relay queue 221. In addition, when the node N220 receives the packet P3, it also checks the source address field and the transmitter address in the packet P3. When the node N220 finds that the source address is the same as the transmitter address, it indicates that the packet P3 is a locally-generated packet. Therefore, the N220 writes the information about the generation time into the tag field in the packet P3, i.e., adds the assigning tag to the packet P3, and then sorts the packet P3 in the local queue 222.

Moreover, as for the current communication network techniques, the network system 200 of the above embodiment can determine the operation states of the first node 210 and the second node 220 through, for example, ripple protocol. The operation states of the ripple protocol include transmit state, receive state, listen state and idle state. Taking the node N220 of the above embodiment for an example, only when the node N220 is in the transmit state, the specific packet is determined to be transmitted. At this time, the node 220 compares the assigning tag of the packet at the first order in the relay queue 221 with that of the packet at the first order in the local queue 222, so as to determine which one is the specific packet.

In order to clearly illustrate the above concepts, another embodiment is described hereinafter. FIG. 5 is a schematic view of wireless chain network queues according to an embodiment of the present invention. Referring to FIG. 5, for the convenience of illustration, five APs (510-550) and a gateway 560 are provided in this embodiment, in which each AP (510-550) includes two queues (a local queue and a relay queue) to sort the packets. Each AP (510-550) uses the relay queue (511, 521, 531, 541 and 551) to sort the packets relayed by other nodes, and uses the local queue (512, 522, 532, 542 and 552) to sort the locally-generated packets. In addition, it is assumed that there is no preceding node ahead of the AP 510 in this embodiment, and thus the relay queue 511 can be determined to be disposed or not optionally, which is not limited herein.

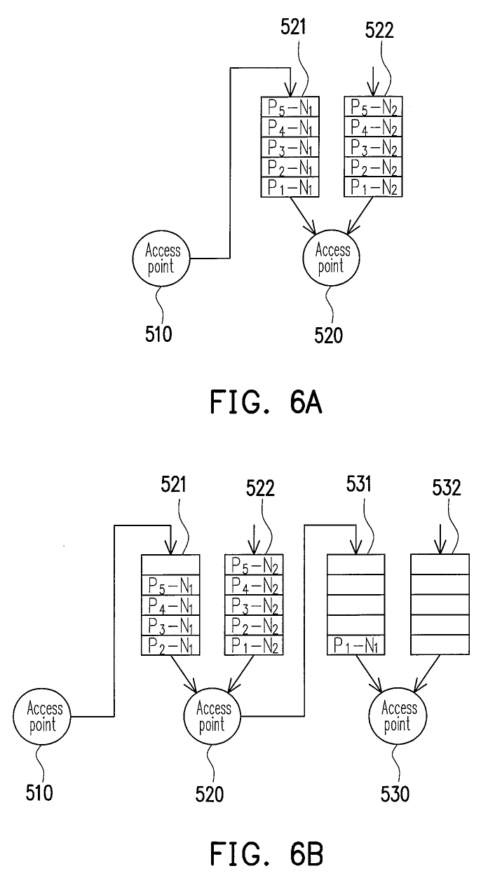

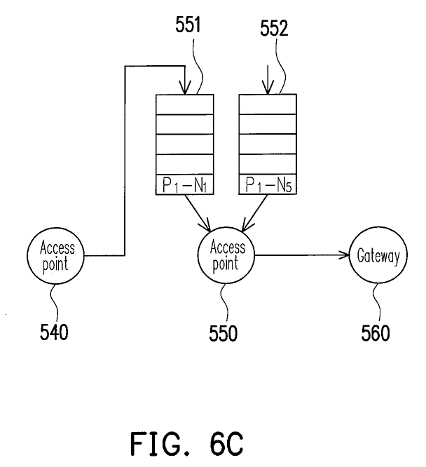

FIGS. 6A-6C are partially enlarged schematic views of FIG. 5 according to an embodiment of the present invention. Referring to FIGS. 6A-6C, for clear illustration, the symbol Pᵢ-Nⱼ indicates the packet Pᵢ in the AP Nⱼ, in which Pᵢ indicates the packet, Nⱼ indicates the AP, where i and j are positive integers. For example, the first packet generated by the AP 510 is indicated as P₁-N₁, and the rest can be deduced by analog. As shown in FIG. 6A, the AP 520 receives five packets transmitted by the AP 510, namely, P₁-N₁, P₂-N₁, P₃-N₁, P₄-N₁ and P₅-N₁. The AP 520 sorts the packets into the queue 521 according to the receiving sequence. In the other aspect, the AP 520 sorts P₁-N₂, P₂-N₂, P₃-N₂, P₄-N₂ and P₅-N₂ to the queue 522 according to the generation time of the locally-generated packets. The lowest positions of the queue 521 and the queue 522 are the positions for the first order in the queues.

Then, the AP 520 determines the sequence for transmission according to the assigning tags corresponding to the packets (i.e., P₁-N₁ and P₁-N₂) at the first order in the queue 521 and the queue 522. As shown in FIG. 6B, it is assumed that the packet P₁-N₁ is generated earlier than the packet P₁-N₂, the AP 520 transmits the packet P₁-N₁ to the queue 531 of the AP 530. At this time, the packet at the first order in the queue 521 is changed to be the packet P₂-N₁, and the rest can be deduced by analog. When the AP 520 wants to transmit the packet, it can determine to transmit which one in the two packets only by comparing the assigning tag in the packet P₂-N₁ with that in the packet P₁-N₂.

According to the above steps, the packet P₁-N₁ is transmitted to the AP 550 through the APs 530, 540 sequentially. As shown in FIG. 6C, the relayed packet P₁-N₁ is sorted in the queue 551. At this time, the AP 550 already has a locally-generated packet P₁-N₅ sorted in the queue 552. It is assumed that the packet P₁-N₁ is generated earlier than the packet P₁-N₅, and after comparing the assigning tag in the packet P₁-N₁ with that in the packet P₁-N₅, the AP 550 firstly transmits the packet P₁-N₁ to the gateway 560. In such a manner, although the AP 550 obtains the packet P₁-N₅ first, the packet P₁-N₁ generated earlier is transmitted to the gateway 560 first.

For example, as for on-line ticketing system, it is assumed that the distance between the AP 510 and the gateway 560 of the on-line ticketing system is about 5 km, and the distance between the AP 550 and the gateway 560 of the on-line ticketing system is about 1 km. If two users at the APs 510 and 550 respectively book the tickets through the on-line ticketing system, the user at the AP 510 sends an instruction of booking ticket at “8:00”, and thus generating the packet P₁-N₁ in FIGS. 6A-C. Then, the user at the AP 550 sends an instruction of booking ticket at “8:05”, and thus generating the packet P₁-N₅ in FIGS. 6A-C. However, the packet P₁-N₁ including the instruction of booking ticket sent by the AP 510 reaches the AP 550 at “8:06” after 5 hops. It is assumed that the packets in the queue in the AP 550 at “8:07” are as shown in FIG. 6C, and the AP 550 is capable of accessing the channel until “8:07”, and AP 550 will determine the packet to be relayed. At this time, although the packet P₁-N₅ arrives at the AP 550 earlier, the time recorded in the tag field of the packet P₁-N₁ generated by the AP 510 is “8:00”, so the packet P₁-N₁ generated by the AP 510 is still first transmitted to the gateway 560, thereby finishing the booking of ticket. In other words, the situation that it is difficult for the AP 510 far away from the gateway 560 to successfully book the ticket due to the distance does not occur.

In view of the above, the method for transmitting packet and the network system thereof provided by this embodiment at least have the following advantages.

1. Corresponding assigning tags are disposed in the packets, so as to determine the order for transmitting the packets, such that a concept of first in first out (FIFO) is achieved in the whole system, thereby fairly arbitrating the sequence for transmitting the packets.

2. When transmitting the packets each time, each node only needs to compare the packets at the first order in the two queues to determine the sequence for transmission, without sorting the packets before the transmission, thereby increasing the transmission speed.

3. The packets received from the preceding node and the locally-generated packets are respectively sorted in different queues, such that large number of operations on sorting the packets are omitted, thereby reducing the operation load of the system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for transmitting packet, applicable to a multi-hop network having a plurality of nodes, comprising:
adding an assigning tag to a packet when the packet entering the multi-hop network;
a specific node among the nodes receiving packets relayed by other nodes in the multi-hop network, and sorting the packets into a relay queue according to the time when the packets are received;
the specific node sorting locally-generated packets into a local queue according to the time when the packets are generated;
the specific node determining whether a packet at the first order in the relay queue or a packet at the first order in the local queue to be a specific packet, according to the assigning tags of the packet at the first order in the relay queue and the packet at the first order in the local queue; and
the specific node transmitting the specific packet.

2. The method for transmitting packet as claimed in claim 1, wherein the assigning tag of each packet is corresponding to a time when the packet is generated.

3. The method for transmitting packet as claimed in claim 1, wherein the assigning tag of each packet is corresponding to a time when the packet arrives in the multi-hop network.

4. The method for transmitting packet as claimed in claim 1, wherein the assigning tag of each packet is corresponding to a serial number of the packet arriving in the multi-hop network.

5. The method for transmitting packet as claimed in claim 1, wherein each packet satisfies a frame format, and the frame format comprises a source address field, a transmitter address field and a tag field.

6. The method for transmitting packet as claimed in claim 5, wherein the assigning tag is recorded in the tag field.

7. The method for transmitting packet as claimed in claim 6, wherein the step of adding the assigning tag to the packet when the packet entering the multi-hop network comprises:
when receiving a packet, the nodes in the multi-hop network determining whether an address recorded in the transmitter address field is the same as an address recorded in the source address field in the received packet; and
if it is determined that the address recorded in the transmitter address field is the same as the address recorded in the source address field, writing the assigning tag in the tag field of the received packet, so as to record the time when the received packet arrives in the multi-hop network.

8. The method for transmitting packet as claimed in claim 6, wherein the step that the specific node receiving packets relayed by other nodes in the multi-hop network and sorting the packets into the relay queue according to the time when the packets are received comprises:
receiving the packets relayed by other nodes in the multi-hop network;
determining whether an address recorded in the transmitter address field is the same as an address recorded in the source address field in the received packet; and
if it is determined that the address recorded in the transmitter address field is different from the address recorded in the source address field, sorting the received packets into the relay queue.

9. The method for transmitting packet as claimed in claim 6, wherein the step that the specific node sorting locally-generated packets into the local queue according to the time when the packets are generated comprises:
determining whether an address recorded in the transmitter address field is the same as an address recorded in the source address field in the locally-generated packet; and
if it is determined that the address recorded in the transmitter address field is the same as the address recorded in the source address field, sorting the locally-generated packets into the local queue.

10. The method for transmitting packet as claimed in claim 1, further comprising:
determining an operation state of nodes in the multi-hop network through a control protocol.

11. The method for transmitting packet as claimed in claim 10, wherein the operation state comprises at least one of a transmit state, a receive state, a listen state and an idle state.

12. The method for transmitting packet as claimed in claim 11, wherein the step that the specific node determining the specific packet comprises:
when the specific node is in the transmit state, comparing the assigning tag of the packet at the first order in the relay queue with that of the packet at the first order in the local queue, so as to determine the specific packet.

13. The method for transmitting packet as claimed in claim 10, wherein the control protocol comprises ripple protocol.

14. A network system, applicable to a multi-hop network, the network system comprising:
a first node; and
a second node, for receiving packets outputted by the first node, sorting the packets into a relay queue according to the time when the packets are received, and sorting locally-generated packets into a local queue according to the time when the packets are generated;
wherein an assigning tag is added to each packet entering the network system; the second node compares the assigning tag of a packet at the first order in the relay queue with that of a packet at the first order in the local queue, so as to determine to transmit the packet at the first order in the relay queue or the packet at the first order in the local queue.

15. The network system as claimed in claim 14, further comprising:
a gateway, for outputting the packets generated by the first node and the second node to Internet.

16. The network system as claimed in claim 14, wherein the assigning tag of each packet is corresponding to a time when the packet is generated.

17. The network system as claimed in claim 14, wherein the assigning tag of each packet is corresponding to a time when the packet arrives in the network system.

18. The network system as claimed in claim 14, wherein the assigning tag of each packet is corresponding to a serial number of the packet arriving in the network system.

19. The network system as claimed in claim 14, wherein each packet satisfies a frame format, and the frame format comprises a source address field, a transmitter address field and a tag field.

20. The network system as claimed in claim 19, wherein the tag field is used for recording the assigning tag.

21. The network system as claimed in claim 19, wherein the second node determines the packet is locally generated or relayed by other nodes according to the source address field and the transmitter address field in the packet.

22. The network system as claimed in claim 14, wherein the first node and the second node include an operation state determined by a control protocol.

23. The network system as claimed in claim 22, wherein the operation state comprises at least one of a transmit state, a receive state, a listen state and an idle state.

24. The network system as claimed in claim 23, wherein when the second node is in the transmit state, the second node compares the assigning tag of the packet at the first order in the relay queue with that of the packet at the first order in the local queue, so as to determine the sequence for transmitting the packets.

25. The network system as claimed in claim 22, wherein the control protocol comprises ripple protocol.
